(19) United States
(12) Patent Application Publication
(10) Pub. No.: US 2009/0040382 A1
(43) Pub. Date: Feb. 12, 2009

(54) Camera apparatus and still image generating method of camera apparatus

(75) Inventors: Shiro Nagaoka, Tokyo (JP); Kuniaki Takahashi, Tokyo (JP); Tatsuhiko Ikehata, Tokyo (JP); Kei Tashiro, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/976,149

(22) Filed: Oct. 22, 2007

(30) Foreign Application Priority Data
Dec. 19, 2006 (JP) 2006-341722

(51) Int. Cl. H04N 5/44; H04N 5/225

(52) U.S. Cl. 348/559; 348/220.1; 382/190; 348/E05.091; 348/E05.107; 348/E05.024

(57) ABSTRACT

According to one embodiment, a camera apparatus includes an extraction device extracting a corresponding “I” picture corresponding to chapter data from “I” pictures included in moving image data while the chapter data specifying a reproduction start point in the moving image data indicating a shot video is being generated.

### CROSS-REFERENCE TO RELATED APPLICATIONS

This application is based upon and claims the benefit of priority from Japanese Patent Application No. 2006-341722, filed on Dec. 19, 2006, the entire contents of which are incorporated herein by reference.

### BACKGROUND

1. Field

One embodiment of the invention relates to a camera apparatus such as a digital camera and a video camera for generating still image data from moving image data indicating a shot video and a still image generating method of the camera apparatus.

2. Description of the Related Art

Conventionally, there is known a camera apparatus (also called an electronic camera apparatus) for importing an optical image of a subject as a still image or a moving image, converting such shot image into image data and electronically saving the data. As a conventional camera apparatus, there are a digital camera mainly shooting a still image and a video camera mainly shooting a moving image.

A variety of the digital cameras and video cameras are widely spread. For example, Japanese Patent Application Publication (KOKAI) No. 2006-165679 (Patent Document 1) discloses a digital camera configured to display, on a display device, a chapter image of moving image data corresponding to a still image selected by a user from still images listed on the display device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing main components of a camera apparatus according to an embodiment of the invention;

FIG. 2 is an exemplary view showing data structure of moving image data compressed by a compression/decompression processing unit in compliance with MPEG-2 in the embodiment;

FIG. 3 is an exemplary view showing the data structure of the moving image data compressed by the compression/decompression processing unit in compliance with MPEG-2, with GOPs and a chapter table in the embodiment;

FIG. 4 is an exemplary view showing an example of a picture composing a GOP in the embodiment; and

FIG. 5 is an exemplary flow chart showing an operation procedure of a still image generating process in the embodiment.

### DETAILED DESCRIPTION

Various embodiments according to the invention will be described hereinafter with reference to the accompanying drawings. In general, according to one embodiment of the invention, a camera apparatus includes an extraction device extracting a corresponding “I” picture corresponding to chapter data from “I” pictures included in moving image data while the chapter data specifying a reproduction start point in the moving image data indicating a shot video is being generated.

Further, a camera apparatus has a moving image data generating device generating moving image data indicating a shot video, a chapter data generating device generating chapter data specifying a reproduction start point in the moving image data generated by the moving image data generating device; and an extraction device extracting a corresponding “I” picture corresponding to the chapter data generated by the chapter data generating device from “I” pictures included in the moving image data.

A still image generating method using a camera apparatus including a moving image data generating device for generating moving image data indicating a shot video is as follows. The method has extracting a corresponding “I” picture corresponding to chapter data from “I” pictures included in moving image data while the chapter data specifying a reproduction start point in the moving image data generated by the moving image data generating device is being generated and storing the extracted corresponding “I” picture as still image data.

(Components of Camera Apparatus)

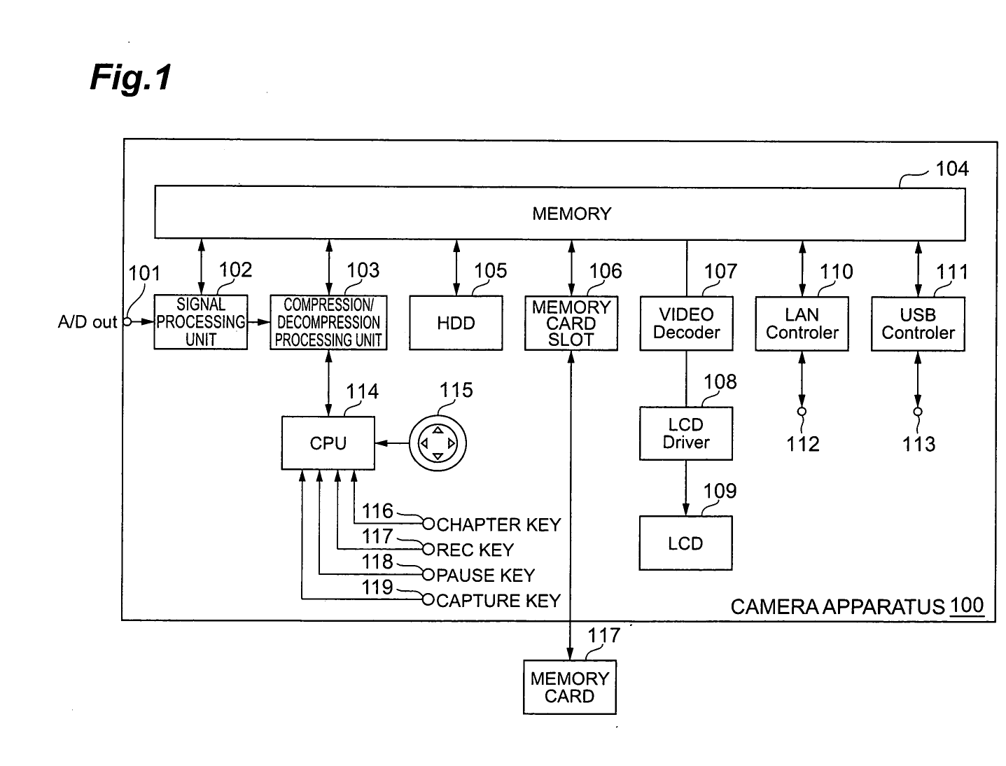

FIG. 1 is a block diagram showing main components of a camera apparatus 100 according to an embodiment of the present invention. The camera apparatus 100 shown in FIG. 1 is a digital video camera apparatus shooting mainly a moving image and also capable of shooting a still image.

The camera apparatus 100 handles data compressed in compliance with MPEG-2 when shooting or reproducing a moving image. When reproducing a moving image, the camera apparatus 100 easily provides trick reproductions such as reverse reproduction, high-speed reproduction, high-speed reverse reproduction, frame forward and frame rewind, in addition to a normal reproduction. Further, unlike a case in which a magnetic tape is employed as an image data recording medium, a random-accessible recording medium such as a later described HDD 105 or memory card 117 is employed in the camera apparatus 100. This allows a user to search a desired video easily.

The camera apparatus 100 is composed of a digital signal output unit 101, a signal processing unit 102, a compression/decompression processing unit 103, a memory 104 and an HDD (Hard Disk Drive) 105.

The camera apparatus 100 also includes a memory card slot 106, a video decoder 107, an LCD (Liquid Crystal Display) driver 108, an LCD 109, an LAN controller 110 and a USB controller 111. Further, the camera apparatus 100 includes a LAN terminal 112, a USB terminal 113, a CPU 114, an operation unit 115, and four operation keys (chapter key 116, REC key 117, PAUSE key 118 and CAPTURE key 119).

The digital signal output unit 101 converts an analog electric signal, which is generated by a CCD (Charge Coupled Device) by using an optical image of a subject obtained through a not-shown lens, into a digital signal and outputs the digital signal to the signal processing unit 102.

The signal processing unit 102 has a function as a moving image data generating device for performing an image processing to the inputted digital signal to thereby generate moving image data indicating a shot video actually shot. Note that the generated moving image data is once stored in the memory 104.

The compression/decompression processing unit 103 compresses the moving image data exported from the memory 104 in compliance with MPEG-2 to thereby produce compressed moving image data, or compresses still image data in compliance with JPEG to produce compressed still image data. Further, in accordance with an instruction from the CPU 114, the compression/decompression processing unit 103 decompresses the compressed moving image data and the compressed still image data.

The memory 104 temporarily stores data to be processed by the signal processing unit 102, data to be processed by the compression/decompression processing unit 103 and an extracted “I” picture 312I which will be described later.

The HDD 105 is an external memory apparatus for recording the compressed moving image data, the sound data and the compressed moving image data to an HD (Hard Disc) built therein. The HDD 105 reads and writes data in the HD (Hard Disc) based on a random access. The HDD 105 has a function as a storing device for storing generated still image data.

The memory card 117 such as an SD memory card (Secure Digital memory card) is inserted into the memory card slot 106, and the memory card slot 106 reads/writes data in the inserted memory card 117. In the memory card 117, compressed moving image data and the like is recorded.

In order to display the shot video that is shot by using the compressed moving image data, the video decoder 107 performs a decoding process to the moving image data to output the data to the LCD driver 108. The video decoder 107 is a software decoder with a decoding program.

The LCD driver 108 converts the decoded moving image data received from the video decoder 107 into a display signal compatible with an interface of the LCD 109. The LCD 109 displays the shot video by using the display signal output from the LCD driver 108.

In accordance with the instruction of the CPU 114, the LAN controller 110 transfers the image data obtained from the memory 104 to a not-shown external device (for example, a DVD decoder or an HDD recorder) connected via the LAN terminal 112. Besides, the LAN controller 110 outputs the moving image data imported from the external device via the LAN terminal 112 to the memory 104.

In accordance with the instruction of the CPU 114, the USB controller 111 transfers the moving image data obtained from the memory 104 to a not-shown external device (for example, a personal computer) connected via the USB terminal 113. Besides, the USB controller 111 outputs the moving image data imported from the external device via the USB terminal 113 to the memory 104.

In accordance with a program stored in a not-shown ROM, the CPU 114 operates as various devices (an extraction device, a detection device and a chapter data generating device) as a feature in this invention. Further, the CPU 114 inputs and outputs a signal into and from the other components to control the entire operation or the respective sequences of the camera apparatus 100.

The operation unit 115 includes a jog dial and a cross key. The operation unit 115 is an operation device operated by a user to select or implement various functions (for example, starting reproduction, stopping reproduction and stopping shooting) of the camera apparatus 100. When the jog dial is operated during a moving image reproduction, reproducing speed is adjusted responding to the operation.

The chapter key 116 inputs a chapter generating instruction to the CPU 114 according to a pressing operation by the user. The chapter generating instruction is data to instruct the CPU 114 to generate later described chapter data (for example, later described chapter data 331) and record the generated chapter data to a chapter table 330. The REC key 117 inputs an instruction to start recording to the CPU 114 according to a pressing operation by the user. The PAUSE key 118 inputs an instruction to pause recording or reproducing to the CPU 114.

The CAPTURE key 119 can be switched “ON” by the user while a moving image is being reproduced. When the CAPTURE key 119 is switched “ON”, an operation signal indicating that the CAPTURE key 119 is switched “ON” is input to the CPU 114. Then, still image data is generated as described below.

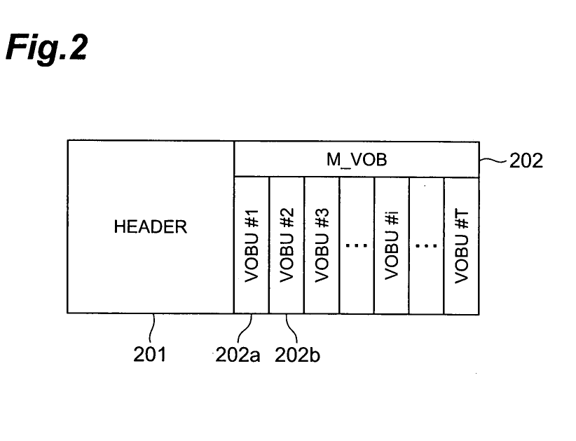

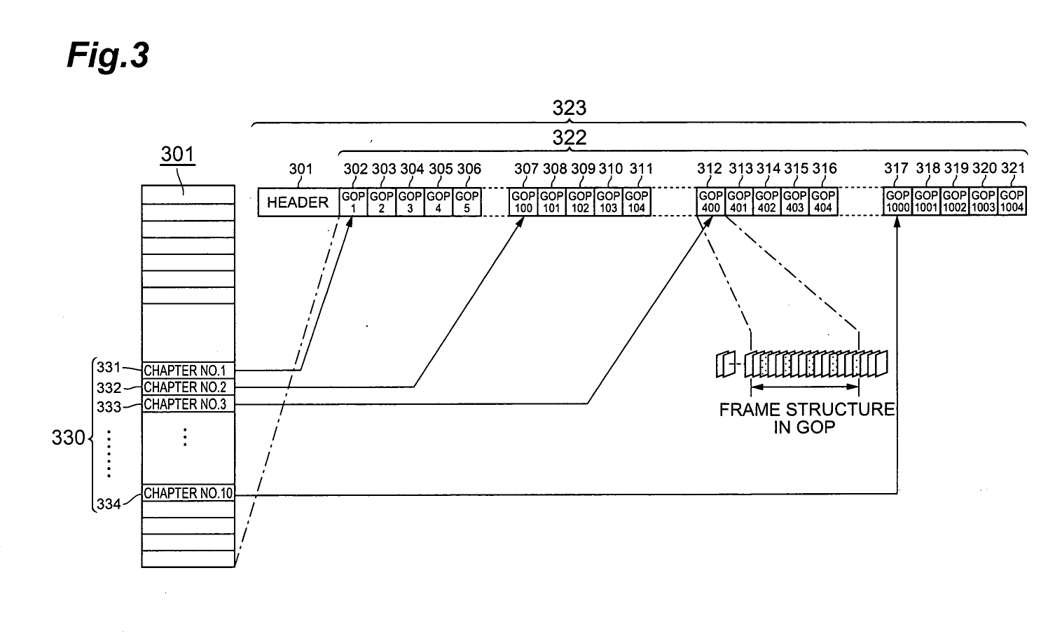

The data structure of the moving image data compressed in compliance with MPEG-2 by the compression/decompression processing unit 103 will be described with reference to FIGS. 2 and 3. Here, FIG. 2 is a view showing a data structure of the moving image data compressed in compliance with MPEG-2 by the compression/decompression processing unit 103.

The moving image data includes a header section 201 and a data section 202. The header section 201 includes VOBU-ENT information section in which sizes of each VOBU (Video Object Block Unit) composing the data section 202 is recorded. The data section 202 includes a plurality of the VOBs (VOB202a, 202b, etc.)

The number of VOBUs is proportional to the length of shooting time. The VOBU includes half-second-length moving image data compressed in compliance with MPEG-2, that is, a later described GOP (Group of Pictures) and a lot of header information. For example, in case of shooting time of 10 minutes, 1200 GOPs are generated, which is obtained by 10 min.×60 sec./0.5. As the sizes of each VOBU are recorded in the VOBU-ENT information section of the header section 201, size information of every 1200 GOPs is recorded.

Similarly, FIG. 3 is a view showing the structure of moving image data 323 compressed in compliance with MPEG-2 by the compression/decompression processing unit 103, with GOPs and the chapter table 330. When reproducing the shot video by using the moving image data 323, in the camera apparatus 100, a certain unit of moving image or a certain pieces of moving images composes a GOP and the moving images can be independently reproduced in a unit of GOP. The GOP includes a 15-frame-length moving image data.

The moving image data 323 includes a header 301 and moving image stream 322 indicating a shot video actually shot.

The header 301 stores management information such as initial data required by the video decoder 107 to decode and reproduce the shot video, for example, an image size and a pixel aspect.

The header 301 also includes the chapter table 330. The generated chapter data is recorded in the chapter table 330. FIG. 3 shows the chapter table 330 including 10 chapter data (chapter data 331, 332, 333 and 334) (here, some of the chapter data is omitted).

Each chapter data includes time point data (also referred to as “PTM (Presentation Time)” or “time point information”) and a chapter number (chapter No.) identifying the chapter data. The time point data indicates the location of a particular GOP among the GOPs included in the moving image stream 322. For example, each of the chapter data 331, 332, 333, 334 includes time point data of the GOPs 302, 307, 312, 317 and the time point data associates the chapter data with the GOPs. Further, the chapter data indicates a reproduction start point of the moving image data.

The moving image stream 322 is composed as data stream including a plurality of GOPs (GOPs 302 to 321) and each GOP is recorded on a half second basis. The GOP is a unit for an edit process by the operation unit 115 and is data of a half second shooting time.

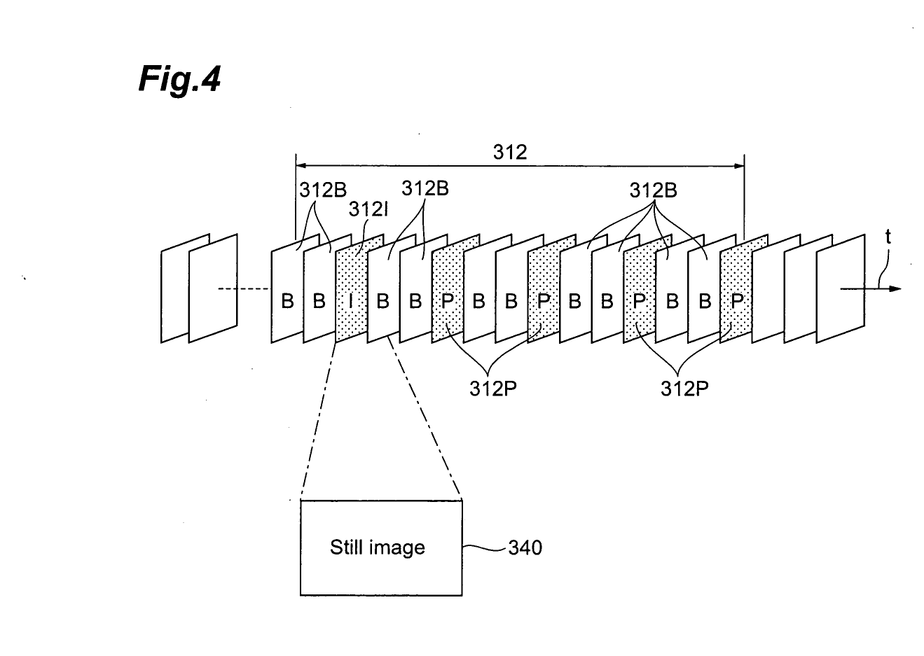

Further, as shown in FIG. 4 in detail, each of the GOPs includes a plurality of pictures (also referred to as “frames”) (15 pictures, in the present embodiment). FIG. 4 shows the GOP 312. Like the GOP 312, each of the GOPs includes three types of pictures: an “I” picture 312I, a “P” picture 312P and a “B” picture 312B, and those pictures are arranged along a time axis t, as shown in FIG. 4.

The “I” picture 312I is an intra-frame coding image (Intra-Picture) and used as a reference image in compressing. The “P” picture 312P is a predictive coding image (Predictive-Picture) and coded based on an inter-frame forward direction prediction with a past “I” picture 312. The “B” picture 312B is a bidirectional predictive coding image (Bidirectionally-predictive-Picture) and is bidirectional predictive coded by the prior or subsequent “P” picture or “I” picture.

Among these pictures, since the “I” picture 312I is encoded within a frame, the “I” picture 312I maintains its independence. In other words, the “I” picture 312I can restore a frame by itself without using other types of pictures. In the embodiment of the present invention, focusing on this point, the “I” picture 312I is extracted.

As described in detail below, in the camera apparatus 100, the “I” picture 312I is extracted from the GOPs, converted into still image data to display a Still Image 340, and stored in the HDD 105. By using the still image data, a still image indicating a position where a chapter data is inserted can be shown.

(Operation Details of Camera Apparatus)

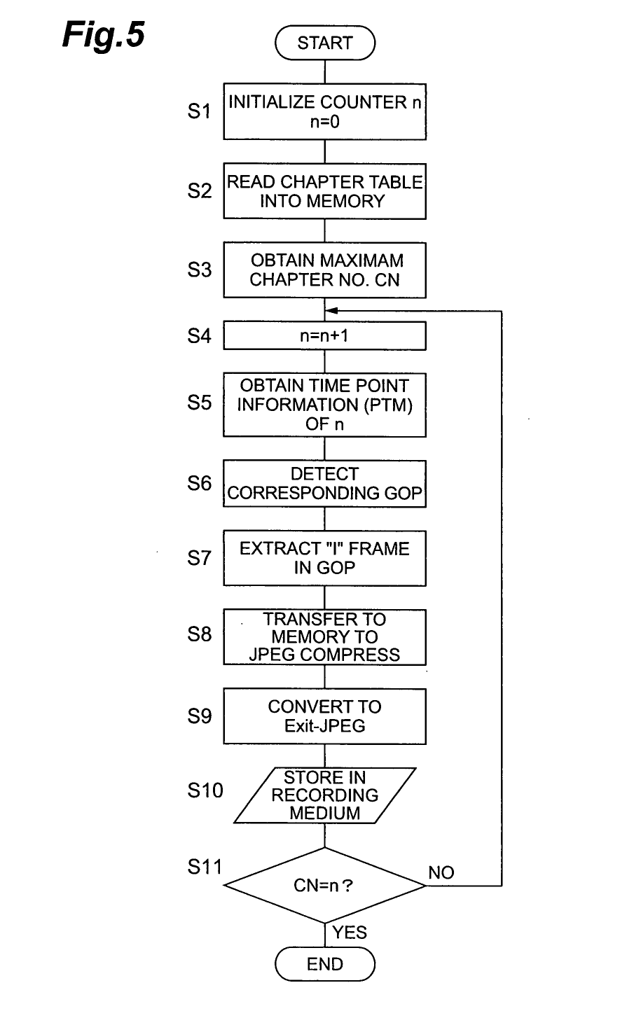

An operation procedure of the still image generating process by the camera apparatus 100 will be described. FIG. 5 is a flowchart showing the operation procedure of the still image generating process. The still image generating process is executed under the control of the CPU 114.

In the camera apparatus 100, chapter data is generated prior to the still image generating process. When the user presses the chapter key 116 while recording or reproducing a moving image, the CPU 114 operates as a chapter data generating device. The CPU generates chapter data, which includes time point information corresponding to the GOP at the timing of the pressing of the chapter key 116, and a chapter number and records the chapter data to a chapter table. Also, when the user pauses with the PAUSE key 118 while recording a moving image, the CPU 114 operates as a chapter data generating device. The CPU 114 generates chapter data including time point information corresponding to the GOP at the timing of pausing and records the chapter data to the chapter table.

Then, when the CAPTURE key 119 is pressed while displaying a moving image on the LCD 109 to switch the key “ON”, the CPU 114 starts a still image generating process and initializes the counter n (sets to “0”) (S1). The counter n is a counter used for comparing the number of chapter processes.

The CPU 114 reads the chapter data of the chapter table 330 included in the header 301 in the moving image data to be a subject of the still image generation and stores the chapter data in the memory 104 (S2).

The CPU 114 obtains a maximum value CN of chapter numbers from the chapter data and sequentially reads chapter data of chapter numbers from “1” to “CN” from the memory 104 (S3). Further, the CPU 114 adds “1” to the counter n (S4) and obtains time point information PTM of the chapter data corresponding to the counter n (S5).

Next, the CPU 114 calculates the position of the corresponding GOP based on the time point information PTM and operates as a detection device to detect the corresponding GOP corresponding to the chapter data among the moving image data 323 (S6). Further, the CPU 114 operates as an extraction device and extracts an “I” picture 312I included in the corresponding GOP (S7). This “I” picture 312I is a corresponding “I” picture.

Next, the CPU 114 transfers the extracted “I” picture 312I to the memory 104 (S8) and instructs the compression/decompression processing unit 103 to compress the “I” picture 312I in compliance with JPEG (the data compressed here is referred to as “compressed data”). Then, the CPU 114 operates as a conversion device to add an Exif (Exchangeable Image File Format) header to the compressed data and convert the data into an image file (still image data) in an Exif-JPEG form (S9), and stores the image file in the HDD 105 or the memory card 117 (S10).

Further, the CPU 114 determines whether or not the counter n is equal to the maximum value CN. When equal, the CPU 114 ends the still image generating process. When not equal, the CPU 114 goes back to the operation of S4 and repeats operations from S4 to S10. With this process, the CPU 114 operates as an extraction control device and repeats from S4 to S10 for every chapter data stored in the chapter table 330. As described above, the camera apparatus 100 extract all corresponding “I” pictures 312I corresponding to each chapter data and generates still image data.

As has been described above, when the user simply switches “ON” the CAPTURE key 119, the camera apparatus 100 extracts all “I” pictures 312P of the corresponding GOP corresponding to the chapter data which is being generated and stores the “I” pictures 312P as still image data.

Accordingly, generating a plurality of chapter data allows to store a plurality of still image data by a single operation. Thus, in the camera apparatus 100, a plurality of still images are generated by a single operation so that troubles required for generating still images can be reduced.

Here, the above described camera apparatus 100 includes the HDD 105 as an external memory apparatus for reading and writing data based on a random access; however, a DVD drive for recording data to a DVD (Digital Versatile Disk) may be employed. Here, with the DVD drive, moving image data can be stored to a rewritable memory medium such as a DVD-RW and DVD-RAM.

The above description is to describe an embodiment of the invention and the apparatus and method are not limited by the above description so that various modifications can be embodied with ease. Further, the apparatus and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising
an extraction device extracting a corresponding “I” picture corresponding to chapter data from “I” pictures included in moving image data while the chapter data specifying a reproduction start point in the moving image data indicating a shot video is being generated.

2. A camera apparatus comprising:
a moving image data generating device generating moving image data indicating a shot video;
a chapter data generating device generating chapter data specifying a reproduction start point in the moving image data generated by said moving image data generating device; and
an extraction device extracting a corresponding “I” picture corresponding to the chapter data generated by said chapter data generating device from “I” pictures included in the moving image data.

3. The camera apparatus according to claim 1, further comprising
an extraction control device controlling said extraction device to extract all “I” pictures corresponding to the chapter data generated by said chapter data generating device as corresponding “I” pictures.

4. The camera apparatus according to claim 1, further comprising
a detection device detecting a corresponding GOP corresponding to the chapter data from GOPs composing the moving image data,
wherein said extraction device extracts the “I” picture, as the corresponding “I” picture, included in the corresponding GOP detected by said detection device.

5. The camera apparatus according to claim 1, further comprising:
a data conversion device converting the corresponding “I” picture extracted by said extraction device into still image data; and
a storing device storing the still image data converted by said data conversion device.

6. A still image generating method using a camera apparatus including a moving image data generating device for generating moving image data indicating a shot video, the method comprising:
extracting a corresponding “I” picture corresponding to chapter data from “I” pictures included in moving image data while the chapter data specifying a reproduction start point in the moving image data generated by the moving image data generating device is being generated; and
storing the extracted corresponding “I” picture as still image data.
